(19) United States
(12) Patent Application Publication
(10) Pub. No.: US 2016/0052812 A1
(43) Pub. Date: Feb. 25, 2016

(54) REJECT RECOVERY REVERSE OSMOSIS (R2RO)

(71) Applicant: Aquatech International Corporation, Canonsburg, PA (US)

(72) Inventors: Ravi Chidambaran, Canonsburg, PA (US); Arun Mittal, Washington, PA (US); Ajanta Sarkar, Pune (IN)

(21) Appl. No.: 14/520,650

(22) Filed: Oct. 22, 2014

(30) Foreign Application Priority Data
Aug. 25, 2014 (IN) 2410/DEL/2014

(51) Int. Cl. C02F 9/00; C02F 1/52; C02F 1/44

(52) U.S. Cl. CPC C02F 9/00; C02F 1/441; C02F 1/444; C02F 1/52; C02F 2303/18; C02F 2001/5218; C02F 2303/22

(57) ABSTRACT

A process for the recovery of purified water from a reverse osmosis reject stream includes preconditioning a reject stream to remove scaling ions and provide preconditioned water; separating any precipitate that forms in the preconditioned water to form a feed stream; subjecting the feed stream to high pressure membrane filtration system including a recirculating, high pressure pump generating a permeate stream and a second reject stream; adding a make-up water stream to the feed stream; and separating the permeate stream as purified water. Additional features and embodiments are also provided.

### CROSS-REFERENCE TO RELATED APPLICATIONS

This application claims priority to Indian national application no. 2410/DEL/2014, filed on Aug. 25, 2014 and claiming priority to U.S. Provisional Patent Application No. 61/869,204, filed on Aug. 23, 2013. That application is incorporated by reference herein.

### BACKGROUND OF THE INVENTION

1. Field of the Invention

Embodiments relate to methods for treatment of water.

2. Background of the Related Art

Effluent treatment, recycling and reuse have become a norm in the last two decades. However, of late disposal standards have become more stringent, and in many cases and many countries a Zero Liquid Discharge (ZLD) facility is typical.

ZLD essentially means that the effluent is first treated in a series of process equipment extracting the maximum possible usable water. The concentrated smaller stream, rich in contaminants, is then passed to either a thermal based evaporation system or to solar ponds. Both these options are heavily capital intensive. Hence it is imperative to minimize the flow that goes into these so that the size of equipment or the solar pond as well as the energy consumed in case of evaporators/crystallizers is minimized.

Effluent streams are mainly contaminated with inorganic and organic dissolved species, suspended and colloidal species, oil, grease, and sparingly soluble inorganic and organic species. The recycle and reuse plants have to be provided with adequate equipment to eliminate these. However, for removal of dissolved inorganic and organics, various membrane based systems (ultrafiltration (UF), microfiltration (MF), nanofiltration (NF), and reverse osmosis (RO)) are used that recover good water (permeate or product) from the effluent stream leaving behind a concentrated stream (reject or concentrate or brine) that is carrying the majority of the contaminants. There are places where the reject stream cannot be disposed of based on the local environmental regulations. This also sometimes results in loss of water in water scarce areas and may contribute to environmental damage in the long term.

Any further recovery of water is often prevented by the foulants as well as the scaling potential of salts and osmotic pressure limitations created by concentration of solutes exceeding their limits rendering the concentrated stream not too suitable for any further membrane treatment. Thus this stream is then passed through to the ZLD system which consists of either evaporator+crystallizer or only crystallizer or evaporator+solar pond, etc.

### BRIEF SUMMARY OF THE INVENTION

Embodiments relate to a Reject Recovery and reduction system based on a novel combination of processes and membrane based units. This system recovers good water from concentrate streams where conventional systems cannot extract further water or further concentrate the reject stream of brine. embodiments may further recover water from the concentrate stream from recycle plants to achieve greater than 98% overall recovery from the effluent stream or to produce a concentrate stream with TDS levels greater than 120000-150000 ppm without the need for expensive thermal processes. Since this focuses on reject recovery and reject reduction from reverse osmosis process, we refer to it as an “R2RO” process.

The level of recovery of the water by membrane systems are often limited by the product pressure rating, the osmotic pressure of membranes and various sealants and foulants that may be present in very high concentrations. Embodiments involve detailed study to overcome these limitations in a combination of unit processes and membrane systems to enhance the overall recovery of the system.

Embodiments are made possible by the following innovative process approach:
1. Reject is preconditioned to reduce or remove ions, which cause scaling and which are likely to saturate and create precipitation if we attempt to recover more water.
2. Any precipitate that forms is separated. This is done to de-saturate the water of inorganic salts so that it can be further concentrated.
3. After the filtration the water may still have high turbidity up to 8-10 NTU and 15 minutes SDI still out of range that is more than 6.6 in the conditioned water due to presence of concentrated contaminants like organics, oil, and other components. Conventional reverse osmosis allows only turbidity less than 0.1NTU and SDI than 5 preferably less than 3.
4. Any build-up of colloidal impurities or inorganic complexes formed during the first stage RO process is optionally removed by a micro filtration or ultrafiltration. This process may not be possible if the water contains oil or heavy organic load. This process will be beneficial with colloidal organic contaminants, which are chelated with metals.
5. This preconditioned water is pumped at very high pressure of up to 150 barg into a configuration of a membrane system. The membrane system can tolerate higher level of turbidities in the recirculating water. A low TDS permeate is generated from highly concentrated feed water by a process of reverse osmosis. This configuration may involve disk type or plate and frame type membrane designed with high pressure housing to withstand design pressures depending upon the application.
The feed water is kept under recirculation mode across membrane, and a make up stream is added to the tank equal to the total flow of reject water and permeate water. However, the flow of recirculation can be 5-20 times the flow of feed water. The recirculation water flow can be added to the suction of the high-pressure pump to optimize energy consumption. The recirculating flow can be adjusted based on the fouling potential of water that higher for high fouling waters and low for low fouling waters. The permeate flow is adjusted to achieve the desired recovery around 90%, and around 10% is allowed to bleed as reject after achieving up to 12-15% concentration in the feed tank based on the water chemistry or desirable recovery as the case may be. If the feed water chemistry or osmotic pressure limitations are not there recovery can be increased further for lower TDS waters.
6. The internal flow distribution system within the membrane ensures minimum laminar flow spaces ensuring minimal fouling. Moreover the membranes are operated in a cross flow mode under higher velocities and limit the recovery per pass so that there is no build up of differential pressure across membranes, which is a measure of fouling. The RO system is designed and operated at pressures to overcome higher osmotic pressures up to 2000 PSI.
7. There may be an increase in the temperature of the recirculating water and that mitigates fouling and also aids solubility of certain inorganic salts thus preventing precipitation.
8. An advanced anti-scalent chemical may be added depending on the existence of scalents in the feed water. This prevents scaling within the membrane system.
9. The flow distribution within the membrane also facilitates efficient cleaning when required to remove foulants and scalents which over a period of time is inevitable.
10. An intermittent step of low pressure permeate flush reduces the need for cleaning. This is facilitated by using a permeate water through a tank and pump.
11. The concentrate or the reject stream from this system can be up to 120000-150000 mg/l in TDS.
12. This reject recovery RO system can eliminate the requirement of a thermal evaporator or a brine concentrator and can directly be fed to the crystallizer or the solar pond. This may save substantial capital costs.
13. This methodology can also be used in high recovery of other high fouling water source, which may not be of high total dissolved solids (TDS). However the operating pressure need to be adjusted based on water TDS and osmotic pressure of brine at the target recovery.
   The flow scheme shown in the figures includes a preconditioning of concentrated feed water, coming from an upstream reverse osmosis unit, by addition of chemicals to de-saturate scaling salts like hardness, a sludge settling and separation device. The clarified and filtered water is taken to an optional ultrafiltration membrane filtration followed by chemical preconditioning and pumping through RO membrane system for removal of TDS.

### BRIEF DESCRIPTION OF THE FIGURES

FIG. 1 shows a conventional reverse osmosis process.

FIG. 2 shows a reverse osmosis process of an embodiment of the invention.

FIG. 3 shows a conventional Zero Liquid Discharge process.

FIG. 4 shows a Zero Liquid Discharge process of an embodiment of the invention.

FIG. 5-7 show graphs corresponding to examples reported herein.

FIG. 8 shows a flow diagram of a process of an embodiment of the invention.

### DETAILED DESCRIPTION OF THE INVENTION

This invention is made possible by the following innovative process approach:
1. Reject is preconditioned to reduce or remove ions, which cause scaling. The preconditioning system is designed for removal of scaling salt, which is likely to cause scaling and limit the recovery based on water chemistry. This could be hardness, silica or any other inorganic salt. This process may involve clarification devise along with the lime, soda ash, magnesium oxide, Ferric chloride or caustic dosing systems and associated equipment like filter press or centrifuge and pumps, etc.
2. Any precipitate that forms is separated and separately disposed of. The clarified water may still have turbidity due to presence of oil or organics. This level of pre treatment is considered inadequate for conventional reverse osmosis where turbidity of less than 0.1 NTU and SDI of less than 5 is desirable and less than 3 is preferable.
3. In a particular embodiment of this method ultrafiltration or microfiltration can be used to increase the recovery through RO to remove certain colloidal impurities, which may have formed during the initial stage of RO concentration in certain water chemistry due to addition of certain chemicals in the pretreatment process like formation of organic chelates.
4. This preconditioned water is taken in a feed tank and pumped at high pressure of up to 150 barg into a configuration of a membrane system. Low TDS permeate is generated from a very concentrated feed water by a process of reverse osmosis. This configuration can be disk type or plate and frame type depending upon the application. The water can also be optionally heated up to increase the solubility of salts depending on the water chemistry or there may be an increase of temperature in the recirculating water temperature. The membrane system is operated at high velocity with the help of a high pressure pump which works on a recirculation mode constantly generating permeate and reject stream after the desired total dissolved solids concentration is achieved in the recirculation stream. A make up water is stream is added to the feed water tank.
5. The internal flow distribution system within the membrane ensures minimum laminar flow spaces ensuring minimal fouling.
6. An advanced anti-scalent chemical may be necessary if critical scalents are present in the feed water. This prevents scaling within the membrane system.
7. The flow distribution within the membrane also facilitates efficient cleaning when required to remove foulants and scalents, which over a period of time is inevitable.
8. The concentrate or the reject stream from this system can be up to 120000-150000 mg/l in TDS.
9. A unique feature of this novel process is ability to achieve high recovery and concentration of brines to achieve up to 12-15% solid content, which is not possible with conventional RO process. This can be done with reject stream of existing RO or to enhance the recovery of a new RO system. This is possible due to desaturation of reject streams by removing like contaminants that can get saturated in the further concentration, operating the RO system of disc or plate and frame type at higher recirculation flows limiting the per pass recovery, using a high pressure RO system which can be operated at higher pressures of 2000-2100 psi and allowing certain inorganic to keep in solution due to high temperature impact. This can be further enhanced by adjusting the recirculation flow to mitigate the impact of fouling by sweeping the surface of membrane with higher or lower velocities where the foulants cannot impact the flux but remain in bulk solution. This method is able to handle high oil and COD contents in the recirculating stream allowing a recovery of 90% or even more. Short cycles of permeate flushing helps to mitigate any fouling. The overall recovery including upstream reverse osmosis could be 98-99% considering the 85-90% in the first RO.

One of skill in the art will recognize other potential advantages of embodiments of the invention. The combination of the processes and membrane systems helps in creating a design with efficient features to meet the desired intents at specific places rather than using a design which is generally made for the overall purpose and creates disadvantages resulting from lack of control of different steps of the process. Following are some potential advantages of this novel process—
1. Extracts additional good usable water and concentrates the brine up to 12-15% from concentrated streams that cannot be concentrated further in conventional membrane desalination and recycle systems.
2. High tolerance to feed COD as well as turbidity.
3. High tolerance to presence of dissolved oil.
4. Ability to operate at high feed pressures up to 150 barg.
5. Reduces the volume of the concentrate/reject stream.
6. Increases the concentration levels of concentrate/reject stream.
7. Can tolerate variation in feed water in terms of scalents like hardness, silica, heavy metals, turbidity and dissolved oil & grease.
8. The membrane system design configuration ensures a steady velocity within the membrane module resulting in low fouling.
9. Increases the temperature to aid solubility of certain contaminants.
10. Lowers recovery per pass and increases the concentration slowly in the bulk solution of recirculating stream preventing sudden precipitation.
11. When being fed to the thermal based ZLD systems, this can eliminate the brine concentrator or reduce the required effects in a multiple effect evaporator.
12. This system can be installed on the down system of existing RO systems to extract more water from the reject streams increasing the recovery, reducing waste and reducing the size of down stream thermal system.

### EXAMPLES

Embodiments of the invention may be better understood by reference to examples and to the figures included herein. An extended study was done on a reject stream of the operating reverse osmosis unit. The base reverse osmosis was operating at 85-90% recovery at different times. The new process was employed with the reject stream, which was being generated by the existing RO. The reject stream was highly concentrated with contaminants to such and extent that it would foul a hollow fiber UF membrane and spirally would RO membrane if we attempt any further water recovery. All the attempts to use a conventional process failed to give any results and experiments were performed with the new process.

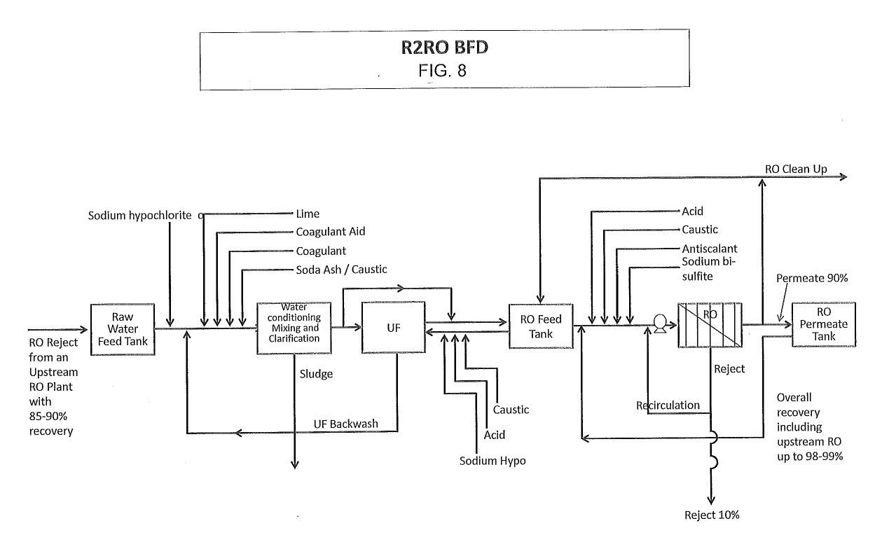

The reject was essentially rich in COD and dissolved oil and had high turbidity. The new process had configuration as depicted in the process flow diagram at FIG. 8. The recovery across the reject stream RO unit was slowly ramped up from 65% to 90% over 14 experiments followed by another 16 experiments at steady recovery of 90%. The system was operated in recycle mode to simulate the worse process conditions within the membrane system. (Table 1: experimental data)

The analysis and inference of the data are as follows:

Operation graphs of Data collected from analysis:

1 Variation in RO Feed Pressure w.r.t. Feed and Permeate Conductivity:

As per log sheet data collected for RO Feed and Permeate conductivity, following is summary of the data collected.

| | Feed | RO Feed | Permeate | | |
|---|---|---|---|---|---|
| Oper- | Conduc- | Conduc- | conduc- | RO Feed | % |
| ating | tivity, | tivity, | tivity, | Pressure, | Rejec- |
| Days | microS/cm | microS/cm | microS/cm | Kg/cm2 | tion |
| 1 | 14569 | 28531 | 1352 | 47.2 | 95% |
| 2 | 14379 | 23743 | 1047 | 37.0 | 96% |
| 3 | 13862 | 25262 | 848 | 38.8 | 97% |
| 4 | 13823 | 26577 | 922 | 38.0 | 97% |
| 5 | 13846 | 17823 | 655 | 34.0 | 96% |
| 6 | 13877 | 23638 | 948 | 34.0 | 96% |
| 7 | 13885 | 31423 | 1248 | 39.8 | 96% |
| 8 | 15123 | 31692 | 1489 | 42.8 | 95% |
| 9 | 15246 | 30415 | 1328 | 42.8 | 96% |
| 10 | 14015 | 28469 | 1273 | 42.6 | 96% |
| 11 | 14046 | 28900 | 1182 | 42.0 | 96% |
| 12 | 12829 | 26608 | 1222 | 40.8 | 95% |
| 13 | 13466 | 26400 | 1201 | 36.2 | 95% |
| 14 | 13665 | 25075 | 1039 | 40.9 | 96% |
| 15 | 14077 | 28315 | 1319 | 43.9 | 95% |
| 16 | 14100 | 29630 | 1601 | 46.4 | 95% |
| 17 | 14100 | 32164 | 1806 | 47.0 | 94% |
| 18 | 13831 | 32627 | 2116 | 49.5 | 94% |
| 19 | 12842 | 34740 | 2017 | 51.1 | 94% |
| 20 | 12297 | 35927 | 2071 | 52.5 | 94% |

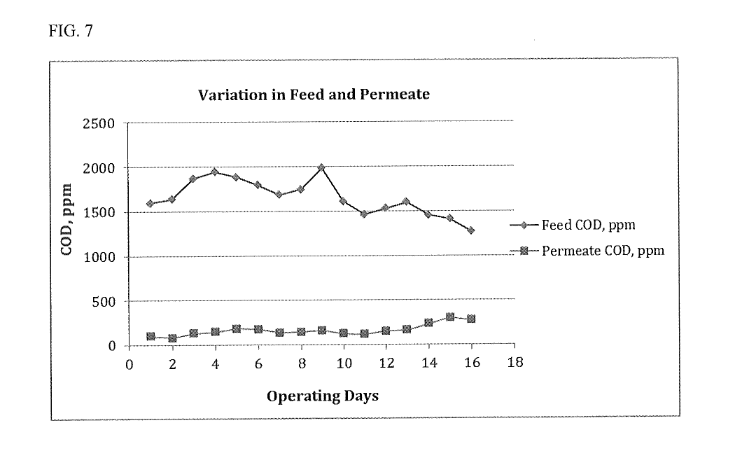

The profile of variation in above data is shown in the graphical representation in FIG. 5.

Observation:

From above graph 5.1, it can be seen that, the feed and permeate conductivity is constant with more than 90% rejection. Also from attached log sheet and graph, it can be observed that, RO feed pressure is increased to achieve 90% recovery. Thus good amount of rejection with TDS is observed at increased recovery also with varying RO feed pressure.

### 2 Variation in Turbidity in RO Feed and Permeate:

The data collected from samples taken at RO Feed and Permeate, turbidity in RO feed and permeate is summarized as below:

| Operating Days | Feed Turbidity, NTU | Permeate Turbidity, NTU |
|---|---|---|
| 1 | 8.8 | 0.34 |
| 2 | 5.9 | 0.29 |
| 3 | 10.0 | 0.16 |
| 4 | 12.2 | 0.31 |
| 5 | 13.5 | 0.61 |
| 6 | 11.1 | 0.54 |
| 7 | 11.3 | 0.46 |
| 8 | 9.3 | 0.38 |
| 9 | 12.3 | 0.36 |
| 10 | 14.5 | 0.25 |
| 11 | 14.2 | 0.39 |
| 12 | 9.7 | 0.41 |
| 13 | 10.3 | 0.38 |
| 14 | 10.0 | 1.00 |
| 15 | 12.6 | 0.51 |
| 16 | 15.4 | 0.70 |

The variation in turbidity is shown graphically as FIG. 6.

### Observations:

From above graph of variation in turbidity in RO feed and permeate, it can be observed that, turbidity in RO permeate is achieved less than 1.0 which is constant.

### 4.3 Variation in RO Feed and Permeate COD:

From the lab analysis of the samples collected at RO feed and permeate, COD in feed and permeate can be summarized as below:

| Operating Days | Feed COD, ppm | Permeate COD, ppm | % Rejection |
|---|---|---|---|
| 1 | 1594 | 102 | 94% |
| 2 | 1640 | 80 | 95% |
| 3 | 1870 | 132 | 93% |
| 4 | 1945 | 149 | 92% |
| 5 | 1884 | 184 | 90% |
| 6 | 1796 | 175 | 90% |
| 7 | 1684 | 137 | 92% |
| 8 | 1744 | 144 | 92% |
| 9 | 1984 | 161 | 92% |
| 10 | 1611 | 126 | 92% |
| 11 | 1460 | 115 | 92% |
| 12 | 1530 | 152 | 90% |
| 13 | 1600 | 165 | 90% |
| 14 | 1454 | 234 | 84% |
| 15 | 1410 | 302 | 79% |
| 16 | 1270 | 272 | 79% |

The graphical representation of above collected data of COD can be shown in FIG. 7.

### Observation:

From above graph 5.2, it can be seen that, feed COD reduced from feed is constant with respect to feed COD content. The rejection measured is almost more than 90% based on the make up water. In this experiment the COD in the recirculation stream is as high as 20000 ppm and the permeate COD was less than 200 ppm, which shows more than 99% rejection.

### CONCLUSION

From above observations, following conclusion can be made on the experimental data done:
The experiment performed at 90% recovery from the existing RO reject which was already operating at 85-90% recovery increasing the overall recovery to 98.0-99% recovery leaving only 1% waste.
The permeate quality obtained with good amount of rejection in TDS/conductivity and parameters like COD, turbidity.
The permeate water can be used for beneficial use and multiple industrial applications reducing fresh draw of water.
The process sustained high turbidity levels of 10-15 NTU in the recirculating water without any adverse impact to the membrane performance in terms of fouling or salt rejection in spite high COD load and higher turbidity and their combination.
The size of the down stream thermal unit to achieve zero liquid discharge will come down to 10% of the original size.

### Applications—

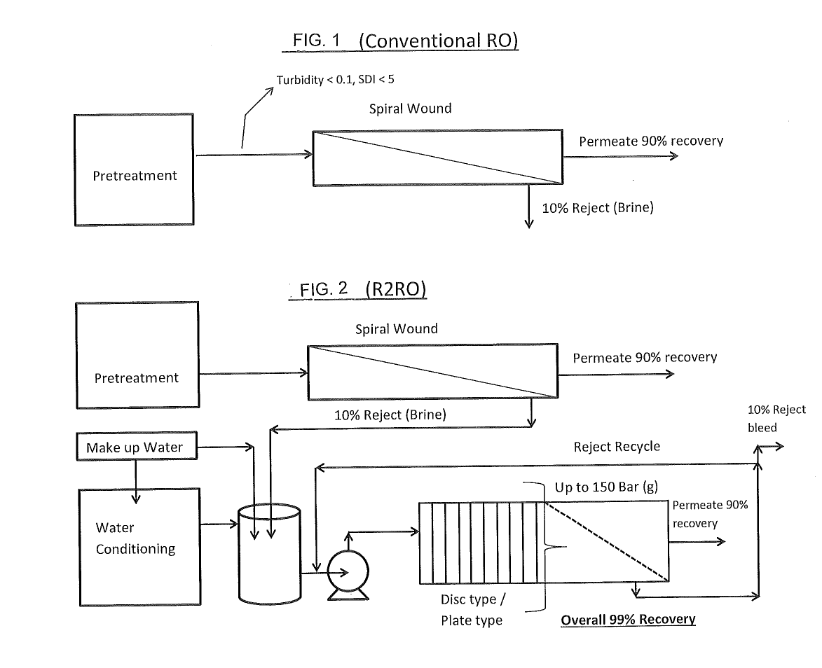

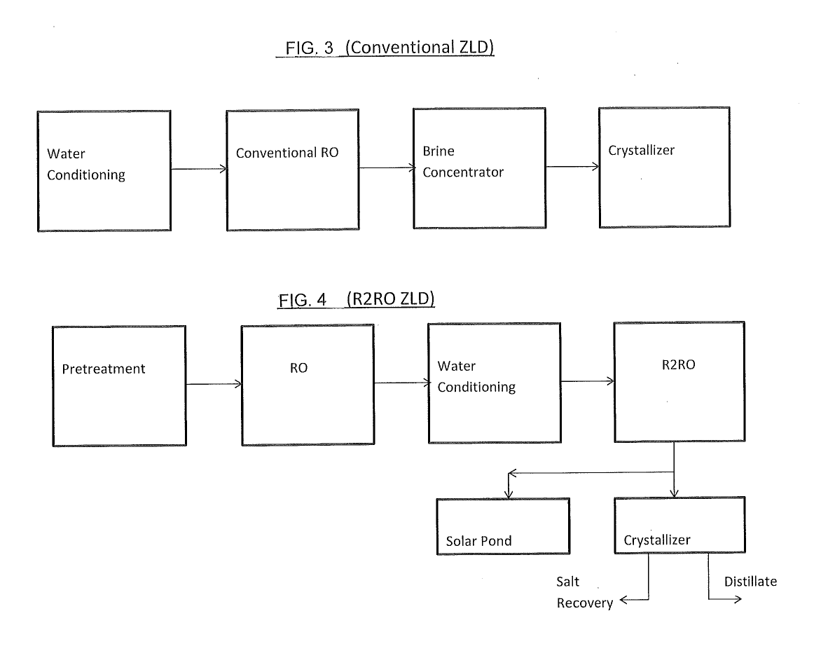

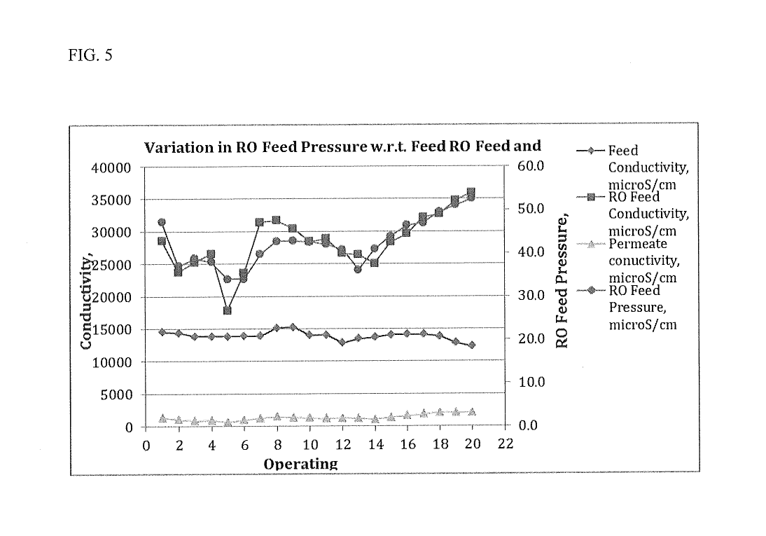

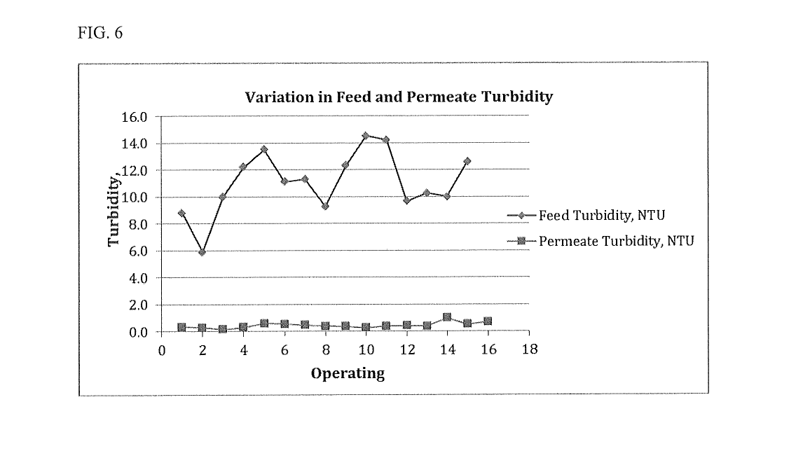

1. This process can be applied to an existing RO to enhance the recovery and reducing waste to maximize the recovery up to 98-99%. This is further illustrated in FIGS. 1 and 2. FIG. 1 gives a conventional approach where FIG. 2 gives an R2RO approach.
2. This process can be applied to increase overall recovery from the RO plant and reduce the size of the thermal plant or eliminate the step of brine concentrator and directly go the crystallizer stage. This is further illustrated in FIGS. 3 and 4. FIG. 3 gives a conventional approach and FIG. 4 gives and R2RO approach.
3. This process can be used to increase the recovery of membrane system where due to increased recovery small quantity of reject water can directly go to solar pond as depicted in FIG. 4.
4. This process can also be used to increase the salt concentration to 12-15% and brine can be sent for beneficial use to extract complete value of resources.
5. The above process can be used in cooling tower blow down applications in multiple industries where there is large consumption of cooling water.
6. This process can also be used in refinery and petrochemicals to recover and recycle large quantity of waste water after the biological processes, where there could be significant contaminants like oil and grease and other organic contaminants contributing to COD. This process can recycle around 98% waste water.
7. This process is highly advantageous to Coal to chemical industries where high water recovery is extremely critical due to environmental considerations and water availability. This will help in reducing thermal evaporator footprint, operating and capital cost of the overall zero liquid system. Here the R2RO approach given FIG. 4 is applied.
8. This process can also be used for FGD wastewater streams to maximize recovery of water.

We claim:

1. A process for achieving high salt concentration and/or high permeate recovery from a reject stream from a first reverse osmosis process including a first reverse osmosis permeate stream and first reverse osmosis reject stream, comprising:
preconditioning the first reverse osmosis reject stream to remove scaling ions and provide preconditioned water;
separating any precipitate that forms in the preconditioned water to form a feed stream;
subjecting the feed stream to high pressure reverse osmosis membrane filtration system including a recirculating, high pressure pump generating a second permeate stream and a second reject stream;
adding a make-up water stream to the feed stream; and
separating the second permeate stream as purified water.

2. The process of claim 1, further comprising removing at least one member of the group consisting of colloidal impurities and inorganic complexes from the reject stream following the preconditioning step.

3. The process of claim 2, wherein said removing step is accomplished by treating the reject stream by at least one of ultrafiltration and microfiltration.

4. The process of claim 1, wherein the high pressure membrane filtration is at a pressure between 100 and 150 barg.

5. The process of claim 1, wherein the high pressure membrane filtration is at a pressure of more than 140 barg.

6. The process of claim 1, wherein the high pressure membrane filtration is conducted in a disk membrane system.

7. The process of claim 1, wherein the high pressure membrane filtration is conducted in a plate and frame membrane system.

8. The process of claim 1, further comprising heating the feed stream.

9. The process of claim 1, further comprising adding an anti-sealant to the feed stream.

10. The process of claim 1, further comprising cleaning the membrane filtration system by a low pressure permeate flush.

11. The process of claim 1, wherein the second reject stream has a salt concentration up to 12%-15%.

12. The process of claim 1, wherein the high pressure membrane filtration system operates between 2000-2100 psi.

13. The process of claim 1, wherein the reject stream has a total dissolved solids content of between 120000-150000 mg/l.

14. The process of claim 1, wherein total water recovery from an RO system including permeate from the first reverse osmosis and permeate from the second reverse osmosis is at least 98% when it is not limited by TDS.

15. A combined reverse osmosis process for achieving high salt concentration and/or high permeate recovery from an upstream first reverse osmosis process and a downstream second reverse osmosis process, said first reverse osmosis process including a first reverse osmosis permeate stream and a first reverse osmosis reject stream and said downstream second reverse osmosis process including a second reverse osmosis process permeate stream and a second reverse osmosis reject stream, comprising:
treating cooling tower blowdown in a first reverse osmosis process to produce a first reverse osmosis process permeate stream and a first reverse osmosis process reject stream;
preconditioning the first reverse osmosis reject stream to remove scaling ions and provide preconditioned water;
separating any precipitate that forms in the preconditioned water to form a feed stream;
subjecting the feed stream to the second reverse osmosis process including a recirculating, high pressure pump generating a second reverse osmosis process permeate stream and a second reverse osmosis process reject stream;
adding a make-up water stream to the feed stream; and
separating the second reverse osmosis process permeate stream as treated water.

16. A combined reverse osmosis process for achieving high salt concentration and/or high permeate recovery from an upstream first reverse osmosis process and a downstream second reverse osmosis process, said first reverse osmosis process including a first reverse osmosis permeate stream and a first reverse osmosis reject stream and said downstream second reverse osmosis process including a second reverse osmosis process permeate stream and a second reverse osmosis reject stream, comprising:
treating recycled and reused refinery water in a first reverse osmosis process to produce a first reverse osmosis process permeate stream and a first reverse osmosis process reject stream;
preconditioning the first reverse osmosis reject stream to remove scaling ions and provide preconditioned water;
separating any precipitate that forms in the preconditioned water to form a feed stream;
subjecting the feed stream to the second reverse osmosis process including a recirculating, high pressure pump generating a second reverse osmosis process permeate stream and a second reverse osmosis process reject stream;
adding a make-up water stream to the feed stream; and
separating the second reverse osmosis process permeate stream as treated water.

17. A combined reverse osmosis process for achieving high salt concentration and/or high permeate recovery from an upstream first reverse osmosis process and a downstream second reverse osmosis process, said first reverse osmosis process including a first reverse osmosis permeate stream and a first reverse osmosis reject stream and said downstream second reverse osmosis process including a second reverse osmosis process permeate stream and a second reverse osmosis reject stream, comprising:
treating recycled and reused coal to chemical production water in a first reverse osmosis process to produce a first reverse osmosis process permeate stream and a first reverse osmosis process reject stream;
preconditioning the first reverse osmosis reject stream to remove scaling ions and provide preconditioned water;
separating any precipitate that forms in the preconditioned water to form a feed stream;
subjecting the feed stream to the second reverse osmosis process including a recirculating, high pressure pump generating a second reverse osmosis process permeate stream and a second reverse osmosis process reject stream;
adding a make-up water stream to the feed stream; and
separating the second reverse osmosis process permeate stream as treated water.

18. A combined reverse osmosis process for achieving high salt concentration and/or high permeate recovery from an upstream first reverse osmosis process and a downstream second reverse osmosis process, said first reverse osmosis process including a first reverse osmosis permeate stream and a first reverse osmosis reject stream and said downstream second reverse osmosis process including a second reverse osmosis process permeate stream and a second reverse osmosis reject stream, comprising:
treating flue gas desulfurization water in a first reverse osmosis process to produce a first reverse osmosis process permeate stream and a first reverse osmosis process reject stream;
preconditioning the first reverse osmosis reject stream to remove scaling ions and provide preconditioned water;
separating any precipitate that forms in the preconditioned water to form a feed stream;
subjecting the feed stream to the second reverse osmosis process including a recirculating, high pressure pump generating a second reverse osmosis process permeate stream and a second reverse osmosis process reject stream;
adding a make-up water stream to the feed stream; and
separating the second reverse osmosis process permeate stream as treated water.

19. The process of claim 1, comprising sending said second reject stream to a crystallizer without a brine concentration step.

20. The process of claim 1, wherein an internal flow distribution system with the membrane filtration system ensures minimal laminar flow space and therefore minimal fouling.

21. The process of claim 19, wherein removal of a brine concentration step decreases operating and capital costs.

22. An apparatus for practicing the process of claim 1.

23. The process of claim 1, wherein the second reject stream has a salt concentration up to 15%.

24. The process of claim 1, wherein total water recovery from an RO system including permeate from the first reverse osmosis and permeate from the second reverse osmosis is up to 99%.
